(19) United States
(12) Patent Application Publication
(10) Pub. No.: US 2019/0387661 A1
(43) Pub. Date: Dec. 26, 2019

(54) USE OF INSECTICIDES FOR CONTROLLING WIREWORMS

(71) Applicants: BAYER CROPSCIENCE AKTIENGESELLSCHAFT, Monheim am Rhein (DE); BAYER AKTIENGESELLSHAFT, Leverkusen (DE)

(72) Inventor: Donald POISSON, Didsbury (CA)

(73) Assignees: BAYER CROPSCIENCE AKTIENGESELLSCHAFT, Monheim am Rhein (DE); BAYER AKTIENGESELLSHAFT, Leverkusen (DE)

(21) Appl. No.: 16/467,097

(22) PCT Filed: Dec. 6, 2017
(86) PCT No.: PCT/EP2017/081704

§ 371 Date: Jun. 6, 2019

(30) Foreign Application Priority Data
Dec. 8, 2016 (EP) 16203048.0
Dec. 8, 2016 (EP) 16203057.1

(51) Int. Cl. A01C 1/06; A01N 37/46; A01N 41/10; A01N 43/56; A01N 43/713; A01N 25/04

(52) U.S. Cl. CPC A01C 1/06; A01N 37/46; A01N 25/04; A01N 43/56; A01N 43/713; A01N 41/10

(57) ABSTRACT

The invention relates to the use of insecticides selected from the ryanodine receptor modulator group consisting of Tetraniliprole, Cyclaniliprole, and Flubendiamide for controlling wireworms, to a method for treating plants or plant parts or the soil for controlling wireworms and to a method for controlling wireworms. in soil, seed and in plants which grow from the seed, by treating the seed or treating the soil with an insecticide insecticides selected from the ryanodine receptor modulator group or formulations containing the same, in particular in cereals.

The invention relates to the use of insecticides selected from the ryanodine receptor modulator group consisting of Tetraniliprole, Cyclaniliprole, and Flubendiamide for controlling wireworms, to a method for treating plants or plant parts or the soil for controlling wireworms and to a method for controlling wireworms. in soil, seed and in plants which grow from the seed, by treating the seed or treating the soil with an insecticide insecticides selected from the ryanodine receptor modulator group or formulations containing the same, in particular in cereals.

Wireworms are the larvae of click beetles of the family of Elateridae representing about 900 different species in North America alone. The adult insect are beetles where the female would lay the eggs in a single manner into the soil scattered over a larger area. The larvae, i.e. the wireworms then live and develop in the soil and feed on underground parts of crops for up to five years, in some species even up to 10 years before they mature into the adult form, the beetle. The feeding on the underground parts does include the roots of the plants but also the planted seed, the seedling, and the underground part of the stem as well as on any other underground part like tubers. Due to the slow development of the wireworms the crops in an infested field are exposed to the damage caused by the wireworms for several years. Wireworms cause significant damage eg yield losses in vegetables like carrots, cucurbits, rutabagas, onions, sweet corn, potatoes; sugar beets, peas; cereals like wheat, barley, rye, triticale; corn, and pulses like lentils, peas, beans (Reddy and Tangtrakulwanich, ISRN Entomology, Volume: 2014 (2014) P. 1-8).

Due to their lifestyle there is no effective post-emergence control of click beetles (the adult form of wireworm) by active ingredients is available, the main recommendation currently is to perform pre-planting treatments like soil incorporation, sidedress or in-furrow applications of active ingredients. In the past active ingredients like gamma HCH (Lindane) or fumigants have been used which are no longer considered as sustainable due to their impact and build-up in the environment. This is especially a concern in crops with high acreage like cereals and pulses. Constant and intensive monitoring of the wireworm population is recommended as well.

Tetraniliprole (Cas-No 1229654-66-3) according to formula (I)

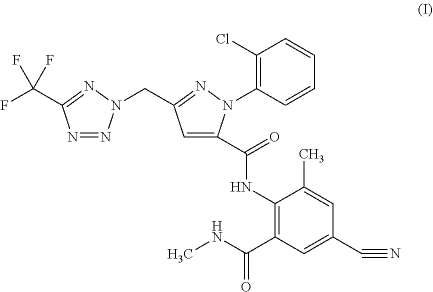 [SMILES: CNC(=O)c1cc(C#N)cc(C)c1NC(=O)c1cc(Cn2nnc(C(F)(F)F)n2)nn1-c1ccccc1Cl]

has the chemical name 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide. Tetraniliprole and methods of producing it are disclosed in WO-A 2001/069502.

Cyclaniliprole (Cas-No 1031756-98-5) according to formula (IV),

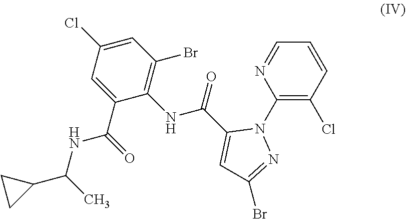 [SMILES: CC(NC(=O)c1cc(Cl)cc(Br)c1NC(=O)c1cc(Br)nn1-c1ncccc1Cl)C1CC1]

has the chemical name 3-bromo-N-[2-bromo-4-chloro-6-[[(1-cyclopropylethyl)amino]carbonyl]phenyl]-1-(3-chloro-2-pyridinyl)-1H-pyrazole-5-carboxamide. Cyclaniliprole and methods of producing it are disclosed in WO-A 2005/077934.

Flubendiamide (Cas No 272451-65-7) according to formula (V)

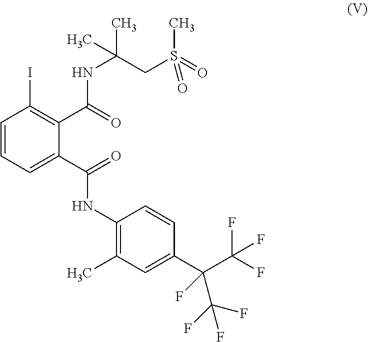 [SMILES: Cc1cc(C(F)(C(F)(F)F)C(F)(F)F)ccc1NC(=O)c1cccc(I)c1C(=O)NC(C)(C)CS(C)(=O)=O]

has the chemical N2-[1,1-Dimethyl-2(methylsulfonyl)ethyl]-3-iodo-N1-[2-methyl-4-[1,2,2,2-tetrafluoro-1-(trifluoromethyl)ethyl}phenyl]-1,2-benzenedicarboxamide. Flubendiamide and methods of producing it are disclosed in EP-A 1006107.

There is therefore an urgent need for insecticides which enable sufficient control of wireworm, in crop plants, especially for broad acre crops, eg cereals, oilseed rape, sunflower, pulses and a wide range of different vegetable crops.

It has now been found that, surprisingly, at least one insecticide selected from the group of consisting of Tetraniliprole, Cyclaniliprole and Flubendiamide is suitable for control of wireworms.

It has now been found that, surprisingly, Tetraniliprole is suitable for control of wireworms.

It has now been found that, surprisingly, Cyclaniliprole is suitable for control of wireworms.

It has now been found that, surprisingly, Flubendiamide is suitable for control of wireworms.

It has now been found that, surprisingly, at least one insecticide selected from the group of consisting of Tetraniliprole, Cyclaniliprole and Flubendiamide is suitable for control of wireworms in crops.

It has now been found that, surprisingly, Tetraniliprole is suitable for control of wireworms in crops.

It has now been found that, surprisingly, Cyclaniliprole is suitable for control of wireworms in crops.

It has now been found that, surprisingly, Flubendiamide is suitable for control of wireworms in crops.

It has now been found that, surprisingly, at least one insecticide selected from the group of consisting of Tetraniliprole, Cyclaniliprole and Flubendiamide is suitable for control of wireworms of the species Agriotes mancus, Hypnoidus bicolor, Limonius californicus, Selatosomus destructor, Limonius ectypus in crops.

It has now been found that, surprisingly Tetraniliprole is suitable for control of wireworms, in particular of the species Agriotes mancus, Hypnoidus bicolor, Limonius californicus, Selatosomus destructor, Limonius ectypus in crops.

It has now been found that, surprisingly Cyclaniliprole is suitable for control of wireworms, in particular of the species Agriotes mancus, Hypnoidus bicolor, Limonius californicus, Selatosomus destructor, Limonius ectypus in crops.

It has now been found that, surprisingly Flubendiamide is suitable for control of wireworms, in particular of the species Agriotes mancus, Hypnoidus bicolor, Limonius californicus, Selatosomus destructor, Limonius ectypus in crops.

It has now been found that, surprisingly, at least one insecticide selected from the group of consisting of Tetraniliprole, Cyclaniliprole, and Flubendiamide applied as a seed treatment is suitable for control of wireworms of the species Agriotes mancus, Hypnoidus bicolor, Limonius californicus, Selatosomus destructor, Limonius ectypus in crops.

It has now been found that, surprisingly Tetraniliprole is suitable for control of wireworms, in particular of the species Agriotes mancus, Hypnoidus bicolor, Limonius californicus, Selatosomus destructor, Limonius ectypus in crops.

It has now been found that, surprisingly Cyclaniliprole applied as a seed treatment is suitable for control of wireworms, in particular of the species Agriotes mancus, Hypnoidus bicolor, Limonius californicus, Selatosomus destructor, Limonius ectypus in crops.

It has now been found that, surprisingly Flubendiamide applied as a seed treatment is suitable for control of wireworms, in particular of the species Agriotes mancus, Hypnoidus bicolor, Limonius californicus, Selatosomus destructor, Limonius ectypus in crops.

In another embodiment combinations comprising at least one insecticide selected from the group of consisting of Tetraniliprole, Cyclaniliprole, and Flubendiamide and at least one insecticide selected from Imidacloprid, Clothianidin, Thiacloprid, Thiamethoxam, Spinosad, Spinoteram, Chloranthraniliprole, Flubendiamide, Cyantraniliprole, Flupyradifuron, Sulfoxaflor, Avermectin, Ivermectin, Avermectin-benzoate, Thiodicarb, Methiocarb and/or at least one fungicide selected from Difenconazole, Ipconazole, Ipfentrifluconazole, Metconazole, Mefentrifluconazole, Prothioconazole, Tebuconazole, Azoxystrobin, Picoxystrobin, Pyraclostrobin, Trifloxystrobin, Bixafen, Benzovindiflupyr, Carbathiin, Fluxapyroxad, Fluopyram, Pydiflumetofen, Penflufen, Sedaxane, Isoflucypram, Fludioxonil, Metalaxyl, Mefenoxam, Mancozeb, Thiram, Captan, can be used for the treatment of seed according to the invention.

In another embodiment combinations comprising at least one insecticide selected from the group of consisting of Tetraniliprole, Cyclaniliprole, and Flubendiamide and at least one insecticide selected from Imidacloprid, Clothianidin, Thiamethoxam, Chloranthraniliprole, Flubendiamide, Cyantraniliprole, Flupyradifuron, Sulfoxaflor, and/or at least one fungicide selected from Difenconazole, Ipconazole, Ipfentrifluconazole, Metconazole, Mefentrifluconazole, Prothioconazole, Tebuconazole, Bixafen, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising at least one insecticide selected from the group of consisting of Tetraniliprole, Cyclaniliprole, and Flubendiamide and at least one insecticide selected from Imidacloprid, Clothianidin, Thiamethoxam, Sulfoxaflor, and/or at least one fungicide selected from Difenconazole, Ipconazole, Ipfentrifluconazole, Metconazole, Mefentrifluconazole, Prothioconazole, Tebuconazole, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising at least one insecticide selected from the group of consisting of Tetraniliprole, Cyclaniliprole, and Flubendiamide and at least one insecticide selected from Imidacloprid, Clothianidin, Thiacloprid, Thiamethoxam, Spinosad, Spinoteram, Chloranthraniliprole, Flubendiamide, Cyantraniliprole, Flupyradifuron, Sulfoxaflor, Avermectin, Ivermectin, Avermectin-benzoate, Thiodicarb, Methiocarb and/or at least one fungicide selected from Difenconazole, Ipconazole, Ipfentrifluconazole, Metconazole, Mefentrifluconazole, Prothioconazole, Tebuconazole, Azoxystrobin, Picoxystrobin, Pyraclostrobin, Trifloxystrobin, Bixafen, Benzovindiflupyr, Carbathiin, Fluxapyroxad, Fluopyram, Pydiflumetofen, Penflufen, Sedaxane, Isoflucypram, Fludioxonil, Metalaxyl, Mefenoxam, Mancozeb, Thiram, Captan, can be used for the treatment of seed according to the invention.

In another embodiment combinations comprising at least one insecticide selected from the group of consisting of Tetraniliprole, Cyclaniliprole, and Flubendiamide and at least one insecticide selected from Imidacloprid, Clothianidin, Thiamethoxam, Chloranthraniliprole, Flubendiamide, Cyantraniliprole, Flupyradifuron, Sulfoxaflor, and/or at least one fungicide selected from Difenconazole, Ipconazole, Ipfentrifluconazole, Metconazole, Mefentrifluconazole, Prothioconazole, Tebuconazole, Bixafen, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising at least one insecticide selected from the group of consisting of Tetraniliprole, Cyclaniliprole, and Flubendiamide and at least one insecticide selected from Imidacloprid, Clothianidin, Thiamethoxam, Sulfoxaflor, and/or at least one fungicide selected from Difenconazole, Ipconazole, Ipfentrifluconazole, Metconazole, Mefentrifluconazole, Prothioconazole, Tebuconazole, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising at least one insecticide selected from the group of consisting of Tetraniliprole, Cyclaniliprole, and Flubendiamide and at least one insecticide selected from Imidacloprid, Clothianidin, Thiacloprid, Thiamethoxam, Spinosad, Spinoteram, Chloranthraniliprole, Flubendiamide, Cyantraniliprole, Flupyradifuron, Sulfoxaflor, Avermectin, Ivermectin, Avermectin-benzoate, Thiodicarb, Methiocarb and/or at least one fungicide selected from Difenconazole, Ipconazole, Ipfentrifluconazole, Metconazole, Mefentrifluconazole, Prothioconazole, Tebuconazole, Azoxystrobin, Picoxystrobin, Pyraclostrobin, Trifloxystrobin, Bixafen, Benzovindiflupyr, Carbathiin, Fluxapyroxad, Fluopyram, Pydiflumetofen, Penflufen, Sedaxane, Isoflucypram, Fludioxonil, Metalaxyl, Mefenoxam, Mancozeb, Thiram, Captan, can be used for the treatment of seed according to the invention.

In another embodiment combinations comprising Tetraniliprole and at least one insecticide selected from Imidacloprid, Clothianidin, Thiacloprid, Thiamethoxam, Spinosad, Spinoteram, Chloranthraniliprole, Flubendiamide, Cyantraniliprole, Flupyradifuron, Sulfoxaflor, Avermectin, Ivermectin, Avermectin-benzoate, Thiodicarb, Methiocarb and/or at least one fungicide selected from Difenconazole, Ipconazole, Ipfentrifluconazole, Metconazole, Mefentrifluconazole, Prothioconazole, Tebuconazole, Azoxystrobin, Picoxystrobin, Pyraclostrobin, Trifloxystrobin, Bixafen, Benzovindiflupyr, Carbathiin, Fluxapyroxad, Fluopyram, Pydiflumetofen, Penflufen, Sedaxane, Isoflucypram, Fludioxonil, Metalaxyl, Mefenoxam, Mancozeb, Thiram, Captan, can be used for the treatment of seed according to the invention.

In another embodiment combinations comprising Tetraniliprole and at least one insecticide selected from Imidacloprid, Clothianidin, Thiamethoxam, Chloranthraniliprole, Flubendiamide, Cyantraniliprole, Flupyradifuron, Sulfoxaflor, and/or at least one fungicide selected from Difenconazole, Ipconazole, Ipfentrifluconazole, Metconazole, Mefentrifluconazole, Prothioconazole, Tebuconazole, Bixafen, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising Tetraniliprole and at least one insecticide selected from Imidacloprid, Clothianidin, Thiamethoxam, Sulfoxaflor, and/or at least one fungicide selected from Difenconazole, Ipconazole, Ipfentrifluconazole, Metconazole, Mefentrifluconazole, Prothioconazole, Tebuconazole, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising Cyclaniliprole and at least one insecticide selected from Imidacloprid, Clothianidin, Thiacloprid, Thiamethoxam, Spinosad, Spinoteram, Chloranthraniliprole, Flubendiamide, Cyantraniliprole, Flupyradifuron, Sulfoxaflor, Avermectin, Ivermectin, Avermectin-benzoate, Thiodicarb, Methiocarb and/or at least one fungicide selected from Difenconazole, Ipconazole, Ipfentrifluconazole, Metconazole, Mefentrifluconazole, Prothioconazole, Tebuconazole, Azoxystrobin, Picoxystrobin, Pyraclostrobin, Trifloxystrobin, Bixafen, Benzovindiflupyr, Carbathiin, Fluxapyroxad, Fluopyram, Pydiflumetofen, Penflufen, Sedaxane, Isoflucypram, Fludioxonil, Metalaxyl, Mefenoxam, Mancozeb, Thiram, Captan, can be used for the treatment of seed according to the invention.

In another embodiment combinations comprising Cyclaniliprole and at least one insecticide selected from Imidacloprid, Clothianidin, Thiamethoxam, Chloranthraniliprole, Flubendiamide, Cyantraniliprole, Flupyradifuron, Sulfoxaflor, and/or at least one fungicide selected from Difenconazole, Ipconazole, Ipfentrifluconazole, Metconazole, Mefentrifluconazole, Prothioconazole, Tebuconazole, Bixafen, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising Cyclaniliprole and at least one insecticide selected from Imidacloprid, Clothianidin, Thiamethoxam, Sulfoxaflor, and/or at least one fungicide selected from Difenconazole, Ipconazole, Ipfentrifluconazole, Metconazole, Mefentrifluconazole, Prothioconazole, Tebuconazole, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising Flubendiamide and at least one insecticide selected from Imidacloprid, Clothianidin, Thiacloprid, Thiamethoxam, Spinosad, Spinoteram, Chloranthraniliprole, Flubendiamide, Cyantraniliprole, Flupyradifuron, Sulfoxaflor, Avermectin, Ivermectin, Avermectin-benzoate, Thiodicarb, Methiocarb and/or at least one fungicide selected from Difenconazole, Ipconazole, Ipfentrifluconazole, Metconazole, Mefentrifluconazole, Prothioconazole, Tebuconazole, Azoxystrobin, Picoxystrobin, Pyraclostrobin, Trifloxystrobin, Bixafen, Benzovindiflupyr, Carbathiin, Fluxapyroxad, Fluopyram, Pydiflumetofen, Penflufen, Sedaxane, Isoflucypram, Fludioxonil, Metalaxyl, Mefenoxam, Mancozeb, Thiram, Captan, can be used for the treatment of seed according to the invention.

In another embodiment combinations comprising Flubendiamide and at least one insecticide selected from Imidacloprid, Clothianidin, Thiamethoxam, Chloranthraniliprole, Flubendiamide, Cyantraniliprole, Flupyradifuron, Sulfoxaflor, and/or at least one fungicide selected from Difenconazole, Ipconazole, Ipfentrifluconazole, Metconazole, Mefentrifluconazole, Prothioconazole, Tebuconazole, Bixafen, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

In another embodiment combinations comprising Flubendiamide and at least one insecticide selected from Imidacloprid, Clothianidin, Thiamethoxam, Sulfoxaflor, and/or at least one fungicide selected from Difenconazole, Ipconazole, Ipfentrifluconazole, Metconazole, Mefentrifluconazole, Prothioconazole, Tebuconazole, Benzovindiflupyr, Fluxapyroxad, Fluopyram, Pydiflumetofen, Penflufen, Sedaxane, Isoflucypram, Fludioxonil, Metalaxyl, Mefenoxam, can be used for the treatment of seed according to the invention.

These treatments preferably also comprise at least one additional fungicide or one additional insecticide or one additional fungicide and one additional insecticide.

Wireworms are the larvae of click beetles of the family of Elateridae. In one embodiment wireworms are the larvae of the genera Agriotes, Aeolus, Athous, Anchastus, Cardiophorus, Ctenicera, Conoderus, Dalopius, Hypnoidus, Limonius, Melanotus, Selatosomus, and Sylvanelater.

In another embodiment wireworms are the larvae of the species selected from the group comprising Agriotes brevis, Agrotis ipsilon, Agriotes lineatus, Agroites mancus, Agriotes obscurus, Agriotes rufipalpis, Agriotes sordidus, Agriotes sparsus, Agriotes sputator, Agriotes ustulatus, Conoderus vespertinus, Ctenicera destructor, Ctenicera pruinina, Dalopius vagus, Hypnoidus bicolor, Hypnoidus abbreviates, Limonius aeger, Limonius agonus, Limonius canus, Limonius californicus, Limonius ectypus, Limonius subauratus, Melanotus communis, Melanotus fissilis, Melanotus similis, Selatosomus destructor, Sylvanelater cylindriformis.

In another embodiment wireworms are the larvae of the species Agriotes lineatus, Agroites mancus, Agriotes obscurus, Agriotes sputator, Dalopius vagus, Hypnoidus bicolor, Hypnoidus abbreviates, Limonius aeger, Limonius agonus, Limonius canus, Limonius californicus, Limonius ectypus, Melanotus communis, Melanotus fissilis, Melanotus similis, Selatosomus destructor, Sylvanelater cylindriformis.

In another embodiment wireworms are the larvae of the species Agriotes lineatus, Agroites mancus, Agriotes obscurus, Agriotes sputator, Dalopius vagus, Hypnoidus bicolor, Hypnoidus abbreviates, Limonius aeger, Limonius agonus, Limonius canus, Limonius californicus, Limonius ectypus, Melanotus communis, Melanotus fissilis, Melanotus similis, Selatosomus destructor, Sylvanelater cylindriformis.

In another embodiment wireworms are the larvae of the species selected from the group comprising Agriotes mancus, Hypnoidus bicolor, Limonius californicus, Selatosomus destructor, Limonius ectypus.

In one embodiment the following crops may be treated to control wireworms, in particular Agriotes mancus, Hypnoidus bicolor, Limonius californicus, Selatosomus destructor, Limonius ectypus: cereals, in particular wheat (winter and spring wheat), durum, rye, triticale, barley, oats, sorghum, beet, beet root, sugar beet, potato, carrot, onion, leek, lettuce, cabbage, bean, in particular broad bean, dry bean, lentils, peas, in particular field peas, Lucerne, oilseed rape, in particular spring oilseed rape, winter oilseed rape, canola, mustard, corn, sunflower, alfalfa, tobacco.

In another embodiment the following crops may be treated to control wireworms, in particular Agriotes mancus, Hypnoidus bicolor, Limonius californicus, Selatosomus destructor, Limonius ectypus: cereals, in particular wheat (winter and spring wheat), durum, rye, triticale, barley, oats, sugar beet, bean, in particular broad bean, dry bean, lentils, peas, in particular field peas, corn, sunflower.

In another embodiment the following crops may be treated to control wireworms, in particular Agriotes mancus, Hypnoidus bicolor, Limonius californicus, Selatosomus destructor, Limonius ectypus: cereals, in particular wheat (winter and spring wheat), durum, rye, triticale, barley, oats, bean, in particular broad bean, dry bean, lentils, peas, corn.

In another embodiment the following crops may be treated to control wireworms, in particular Agriotes mancus, Hypnoidus bicolor, Limonius californicus, Selatosomus destructor, Limonius ectypus: cereals, in particular wheat (winter and spring wheat), durum, rye, triticale, barley, oats, bean, corn.

In another embodiment the following crops may be treated to control wireworms, in particular Agriotes mancus, Hypnoidus bicolor, Limonius californicus, Selatosomus destructor, Limonius ectypus: wheat (winter and spring wheat), durum, rye, triticale, barley, oats.

The present invention accordingly provides for the use of at least one insecticide selected from the group of consisting of Tetraniliprole, Cyclaniliprole, and Flubendiamide for control of wireworms, in particular of the species Agriotes mancus, Hypnoidus bicolor, Limonius californicus, Selatosomus destructor, Limonius ectypus, in particular as a seed treatment while simultaneously providing plant stand protection and crop tolerance.

In one embodiment “control of wireworms” means a significant reduction in damage on the crop by wireworms, compared with the untreated plant or plants, preferably a significant reduction (by 40-79%), compared with the untreated plant or plants (100%); more preferably, the damage on the crop is entirely suppressed (by 70-100%). The control is for protection of a plant or plants which have not yet been infected.

In another embodiment “control of wireworms” means a significant reduction in infection on the crop by wireworms, compared with the untreated plant or plants, preferably a significant reduction (by 40-79%), compared with the untreated plant or plants (100%); more preferably, the infection on the crop is entirely suppressed (by 70-100%). The control is for protection of a plant or plants which have not yet been infected.

In another embodiment “control of wireworms” means an increase in biomass in the crop expressed as NDVI (Normalized Difference Vegetation Index), compared with the untreated plant, preferably an increase (by 5-10% in NDVI), compared with the untreated plant (100%); more preferably, the biomass is even more increased (by at least 21% in NDVI). The control is for plants which have not yet been infected.

In another embodiment “control of wireworms” means an increase in plant count in the crop expressed, compared with the untreated plant, preferably an increase in plant count (by 15-25% in plant counts), compared with the untreated plant (100%); more preferably, the plant count is even more increased (by at least 21% in plant counts). The control is for plants which have not yet been infected.

Untreated plant may also be a plant treated with fungicide only and having not received an insecticide treatment.

Plant count is defined as the number of plants in a certain area, eg no of plants per square meter at a certain growth stage.

Biomass is the amount of plant material of a crop. It may be measured using NDVI. NDVI is defined as The NDVI algorithm subtracts the red reflectance values from the near-infrared and divides it by the sum of near-infrared and red bands (http://earthobservatory.nasa.gov/Features/MeasuringVegetation/)

NDVI=(NIR−RED)/(NIR+RED) with RED being the reflectance values in the visible red regions of light and NIR being the reflectance values in the near infrared regions.

In one embodiment the treatment to control wireworms using at least one insecticide selected from the group of consisting of Tetraniliprole, Cyclaniliprole, and Flubendiamide is performed on plants and plant parts or seed in spray application, by immersion, spraying, evaporation, fogging, scattering, painting on, injection, in seed treatment, in drip and drench applications, in-furrow applications, on-seed application and overall soil incorporation, chemigation, i.e. by addition of the active ingredients to the irrigation water, and in hydroponic/mineral systems.

The compositions comprising at least one insecticide selected from the group of consisting of Tetraniliprole, Cyclaniliprole, and Flubendiamide can be prepared prior to the treatment by mixing the individual active compounds. Alternatively, the treatment is carried out successively by initially using at least one insecticide selected from the group of consisting of Tetraniliprole, Cyclaniliprole, and Flubendiamide, followed by treatment with another active ingredient. However, it is also possible to treat the plants or plant parts first with an active compound, followed by treatment with at least one insecticide selected from the group of consisting of Tetraniliprole, Cyclaniliprole, and Flubendiamide.

In one embodiment the protection of crop plants by seed treatment is disclosed with of at least one insecticide selected from the group of consisting of Tetraniliprole, Cyclaniliprole, and Flubendiamide or compositions comprising the same.

In another embodiment the protection of crop plants by seed treatment is disclosed with Tetraniliprole, or compositions comprising the same.

Combinations of at least one insecticide selected from the group of consisting of Tetraniliprole, Cyclaniliprole, and Flubendiamide, with substances including insecticides, fungicides and bactericides, fertilizers, growth regulators, can likewise find use in the control of plant diseases in the context of the present invention.

The use of at least one insecticide selected from the group of consisting of Tetraniliprole, Cyclaniliprole and Flubendiamide is effected preferably with a dosage between 0.01 and 3 kg/ha, more preferably between 0.05 and 2 kg/ha, especially preferably between 0.1 and 1 kg/ha.

The use of Tetraniliprole is effected preferably with a dosage between 0.01 and 3 kg/ha, more preferably between 0.05 and 2 kg/ha, especially preferably between 0.1 and 1 kg/ha.

Depending on their particular physical and/or chemical properties, the active ingredients according to this invention can be converted in accordance with the invention to the customary formulations, such as solutions, emulsions, suspensions, powders, foams, pastes, granules, aerosols and microencapsulations in polymeric substances and in coating materials for seed, and also ULV cool and warm fogging formulations.

These formulations are produced in a known manner, for example by mixing the active ingredients with extenders, i.e. liquid solvents, liquefied gases under pressure and/or solid carriers, optionally using surfactants, i.e. emulsifiers and/or dispersants, and/or foam formers. If the extender used is water, it is also possible to use, for example, organic solvents as auxiliary solvents. Useful liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, alcohols such as butanol or glycol and their ethers and esters, ketones such as acetone, methyl ethyl ketone, methyl isobutyl ketone or cyclohexanone, strongly polar solvents such as dimethylformamide or dimethyl sulphoxide, or else water. Liquefied gaseous extenders or carriers are understood to mean those liquids which are gaseous at standard temperature and under standard pressure, for example aerosol propellants such as halohydrocarbons, or else butane, propane, nitrogen and carbon dioxide. Useful solid carriers are: for example natural rock flours such as kaolins, clays, talc, chalk, quartz, attapulgite, montmorillonite or diatomaceous earth, and synthetic rock flours such as finely divided silica, alumina and silicates. Useful solid carriers for granules are: for example crushed and fractionated natural rocks such as calcite, pumice, marble, sepiolite, dolomite, and synthetic granules of inorganic and organic flours, and also granules of organic material such as sawdust, coconut shells, maize cobs and tobacco stalks. Useful emulsifiers and/or foam generators are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Useful dispersants include: for example lignosulphite waste liquors and methylcellulose.

In the formulations it is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids. Further additives may be mineral and vegetable oils.

It is possible to use colorants such as inorganic pigments, for example iron oxide, titanium oxide and Prussian Blue, and organic dyes such as alizarin dyes, azo dyes and metal phthalocyanine dyes, and trace nutrients such as salts of iron, manganese, boron, copper, cobalt, molybdenum and zinc.

The formulations contain generally between 0.1 and 95 per cent by weight of active ingredient, preferably between 0.5 and 90%.

Seed Treatment

The treatment of the seed of plants has been known for a long time and is the subject of constant improvements. Nevertheless, the treatment of seed gives rise to a series of problems which cannot always be solved in a satisfactory manner. For instance, it is desirable to develop methods for protecting the seed, the germinating plant and the resulting plants or plant parts, which dispense with, or at least significantly reduce, the additional deployment of crop protection products after planting or after emergence of the plants. It is additionally desirable to optimize the amount of active ingredient used in such a way as to provide the best possible protection for the seed and the germinating plant from attack by wireworms, in particular of the species Agriotes mancus, Hypnoidus bicolor, Limonius californicus, Selatosomus destructor, Limonius ectypus but without damaging the plant itself by the active ingredient used.

The present invention therefore relates more particularly also to a method for treating seed to control wireworms, in particular of the species Agriotes mancus, Hypnoidus bicolor, Limonius californicus, Selatosomus destructor, Limonius ectypus in the plants which grow from the seed, by treating the seed with wireworms, in particular of the species Agriotes mancus, Hypnoidus bicolor, Limonius californicus, Selatosomus destructor, Limonius ectypus. The seed is more preferably a cereal seed, for example wheat.

The invention likewise relates to the use of at least one insecticide selected from the group of consisting of Tetraniliprole, Cyclaniliprole, and Flubendiamide for treatment of seed to control wireworms, in particular of the species Agriotes mancus, Hypnoidus bicolor, Limonius californicus, Selatosomus destructor, Limonius ectypus in the seed, the germinating plant and the plants or plant parts which grow therefrom.

In the context of the present invention, at least one insecticide selected from the group of consisting of Tetraniliprole, Cyclaniliprole, and Flubendiamide is applied to the seed alone or in a suitable formulation. Preferably, the seed is treated in a state in which it is stable enough to avoid damage during treatment. In general, the seed may be treated at any time between harvest and sowing. The seed typically used has been separated from the plant and freed from cobs, shells, stalks, coats, hairs or the fruit flesh. For example, it is possible to use seed which has been harvested, cleaned and dried to a moisture content of less than 15% by weight. Alternatively, it is also possible to use seed which, after drying, for example, has been treated with water and then dried again.

When treating the seed, it must generally be ensured that the amount of at least one insecticide selected from the group of consisting of Tetraniliprole, Cyclaniliprole, and Flubendiamide, applied to the seed and/or of further additives is selected such that the germination of the seed is not impaired, and that the resulting plant is not damaged. This should be noted in particular in the case of active ingredients which can have phytotoxic effects at particular application rates.

At least one insecticide selected from the group of consisting of Tetraniliprole, Cyclaniliprole, and Flubendiamide can be applied directly, i.e. without containing any further components and without having been diluted. In general, it is preferable to apply the active ingredients at least one insecticide selected from the group of consisting of Tetraniliprole, Cyclaniliprole, and Flubendiamide, preferably Tetraniliprole, to the seed in the form of a suitable formulation. Suitable formulations and methods for seed treatment are known to those skilled in the art and are described, for example, in the following documents: U.S. Pat. Nos. 4,272,417 A, 4,245,432 A, 4,808,430 A, 5,876,739 A, US 2003/0176428 A1, WO 2002/080675 A1, WO 2002/028186 A2.

The insecticide selected from the group of consisting of Tetraniliprole, Cyclaniliprole, and Flubendiamide can be converted to the customary seed dressing formulations, such as solutions, emulsions, suspensions, powders, foams, slurries or other coating materials for seed.

These formulations are produced in a known manner, by mixing the active ingredients or active ingredient combinations with customary additives, for example customary extenders and solvents or diluents, dyes, wetting agents, dispersants, emulsifiers, defoamers, preservatives, secondary thickeners, stickers, gibberellins and also water.

Useful dyes which may be present in the seed dressing formulations usable in accordance with the invention are all dyes customary for such purposes. It is possible to use both sparingly water-soluble pigments and water-soluble dyes. Examples include the dyes known under the Rhodamine B, C.I. Pigment Red 112 and C.I. Solvent Red 1 names.

The wetting agents which may be present in the seed dressing formulations usable in accordance with the invention include all substances which promote wetting and are customary for formulation of active agrochemical ingredients. Usable with preference are alkyl naphthalenesulphonates, such as diisopropyl or diisobutyl naphthalenesulphonate.

The dispersants and/or emulsifiers which may be present in the seed dressing formulations usable in accordance with the invention include all nonionic, anionic and cationic disperants which are customary for formulation of active agrochemical ingredients. Usable with preference are nonionic or anionic dispersants or mixtures of nonionic or anionic dispersants. Suitable nonionic dispersants include especially ethylene oxide-propylene oxide block polymers, alkylphenol polyglycol ethers and tristyrylphenol polyglycol ethers, and the phosphated or sulphated derivatives thereof. Suitable anionic dispersants are especially lignosulphonates, polyacrylic acid salts and arylsulphonate-formaldehyde condensates.

The defoamers which may be present in the seed dressing formulations usable in accordance with the invention include all foam-inhibiting substances customary for formulation of active agrochemical ingredients. Usable with preference are silicone defoamers and magnesium stearate.

The preservatives which may be present in the seed dressing formulations usable in accordance with the invention include all substances usable for such purposes in agrochemical formulations. Examples include dichlorophene and benzyl alcohol hemiformal.

Useful secondary thickeners which may be present in the seed dressing formulations usable in accordance with the invention include all substances usable for such purposes in agrochemical formulations. Preferred examples include cellulose derivatives, acrylic acid derivatives, xanthan, modified clays and finely divided silica.

Useful stickers which may be present in the seed dressing formulations usable in accordance with the invention are all customary binders usable in seed dressing compositions. Preferred examples include polyvinylpyrrolidone, polyvinyl acetate, polyvinyl alcohol and tylose.

The gibberellins which may be present in the seed dressing formulations usable in accordance with the invention are preferably gibberellins A1, A3 (=gibberellic acid), A4 and A7, particular preference being given to using gibberellic acid. The gibberellins are known (cf. R. Wegler “Chemie der Pflanzenschutz-und Schädlingsbekämpfungsmittel” [Chemistry of Crop Protection and Pest Control Compositions], vol. 2, Springer Verlag, 1970, p. 401-412).

The seed dressing formulations usable in accordance with the invention can be used to treat a wide variety of different kinds of seed either directly or after preceding dilution with water. For instance, the concentrates or the preparations obtainable therefrom by dilution with water can be used to dress the seed of cereals, such as wheat, barley, rye, oats and triticale, and the seed of maize, rice, oilseed rape, peas, beans, cotton, sunflowers and beet, or else vegetable seeds of a wide variety of different kinds. The seed dressing preparations usable in accordance with the invention or the dilute preparations thereof can also be used to dress seed of transgenic plants. In this case, it is also possible for additional synergistic effects to occur in interaction with substances formed by expression.

For treatment of seed with the seed dressing formulations usable in accordance with the invention, or the preparations prepared therefrom by adding water, all mixing units usable customarily for the seed dressing are useful. Specifically, the seed dressing procedure is to introduce the seed into a mixer, to add the particular desired amount of seed dressing formulations, either as such or after preceding dilution with water, and to mix until the formulation is distributed homogeneously on the seed. This may be followed by a drying operation.

The application rate of seed dressing formulations usable in accordance with the invention may vary within a relatively wide range. It is guided by the particular content of the active ingredients in the formulations and by the seed. The application rates of the insecticides selected from the group of consisting of Tetraniliprole, Cyclaniliprole, and Flubendiamide are generally between 0.1 and 400 g per 100 kilogram of seed, preferably between 2 g and 200 g per 100 of kilogram seed, very preferably between 5 g and 100 g per 100 kilogram of seed.

The application rates of Tetraniliprole is generally between 0.1 and 200 g per 100 kilogram of seed, preferably between 2 and 400 g per kilogram of 100 seed, very preferably between 5 g and 200 g per 100 kilogram of seed.

The application rates of Flubendiamide is generally between 0.1 and 500 g per 100 kilogram of seed, preferably between 2 g and 250 g per kilogram of seed, very preferably between 5 g and 200 g per 100 kilogram of seed.

The application rates of Tetraniliprole may also be between 15 and 30 g per 100 kilogram of seed, preferably 20 g per kilogram of 100 seed, very preferably between 25 g per 100 kilogram of seed.

The application rates of Flubendiamide may also be between 15 and 30 g per 100 kilogram of seed, preferably 20 g per 100 kilogram of seed, very preferably between 25 g per 100 kilogram of seed.

Particular preference is given in accordance with the invention to treating plants of the plant cultivars which are each commercially available or in use. Plant cultivars are understood to mean plants which have new properties (“traits”) and which have been obtained by conventional breeding, by mutagenesis or with the aid of recombinant DNA techniques. Crop plants may accordingly be plants which can be obtained by conventional breeding and optimization methods or by biotechnology and genetic engineering methods or combinations of these methods, including the transgenic plants and including the plant varieties which can and cannot be protected by plant variety rights.

The method according to the invention can thus also be used for the treatment of genetically modified organisms (GMOs), for example plants or seeds. Genetically modified plants (or transgenic plants) are plants in which a heterologous gene has been integrated stably into the genome. The term “heterologous gene” means essentially a gene which is provided or assembled outside the plant and which, on introduction into the cell nucleus genome, imparts new or improved agronomic or other properties to the chloroplast genome or the mitochondrial genome of the transformed plant by virtue of it expressing a protein or polypeptide of interest or by virtue of another gene which is present in the plant, or other genes which are present in the plant, being downregulated or silenced (for example by means of antisense technology, co-suppression technology or RNA technology [RNA interference]). A heterologous gene present in the genome is likewise referred to as a transgene. A transgene which is defined by its specific presence in the plant genome is referred to as a transformation or transgenic event.

Plants and plant cultivars which are preferably treated according to the invention include all plants which have genetic material which imparts particularly advantageous, useful traits to these plants (whether obtained by breeding and/or biotechnological means).

Plants and plant cultivars which may also be treated in according to invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients or shade avoidance.

Plants and plant cultivars which may also be treated according to the invention are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to early flowering, flowering control for hybrid seed production, seedling vigour, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may also be treated according to the invention are hybrid plants that already express the characteristic of heterosis or hybrid vigour which generally results in higher yield, vigour, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in maize) be produced by detasseling, i.e. the mechanical removal of the male reproductive organs (or male flowers), but, more typically, male sterility is the result of genetic determinants in the plant genome. In that case, and especially when seed is the desired product to be harvested from the hybrid plants, it is typically useful to ensure that male fertility in hybrid plants that contain the genetic determinants responsible for the male sterility is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmatic male sterility (CMS) were for instance described in Brassica species (WO 1992/005251, WO 1995/009910, WO 1998/27806, WO 2005/002324, WO 2006/021972 and US 6,229,072). However, genetic determinants for male sterility can also be located in the nuclear genome. Male-sterile plants can also be obtained by plant biotechnology methods such as genetic engineering. A particularly useful means of obtaining male-sterile plants is described in WO 89/10396, in which, for example, a ribonuclease such as barnase is selectively expressed in the tapetum cells in the stamens. Fertility can then be restored by expression in the tapetum cells of a ribonuclease inhibitor such as barstar (e.g. WO 1991/002069).

Plants or plant cultivars (obtained by plant biotechnology methods such as genetic engineering) which may likewise be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 2001/66704). It can also be a mutated EPSPS, as described, for example, in EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. Nos. 5,776,760 and 5,463,175. Glyphosate-tolerant plants can also be obtained by expressing a gene that encodes a glyphosate acetyl transferase enzyme as described, for example, in WO 2002/036782, WO 2003/092360, WO 2005/012515 and WO 2007/024782. Glyphosate-tolerant plants can also be obtained by selecting plants containing naturally occurring mutations of the above-mentioned genes as described, for example, in WO 2001/024615 or WO 2003/013226.

Other herbicide-resistant plants are for example plants that have been made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is, for example, an enzyme encoding a phosphinothricin acetyltransferase (such as the bar or pat protein from Streptomyces species). Plants expressing an exogenous phosphinothricin acetyltransferase are for example described in U.S. Pat. Nos. 5,561,236; 5,648,477; 5,646,024; 5,273,894; 5,637,489; 5,276,268; 5,739,082; 5,908,810 and 7,112,665.

Further herbicide-tolerant plants are also plants that have been made tolerant to the herbicides inhibiting the enzyme hydroxyphenylpyruvatedioxygenase (HPPD). Hydroxyphenylpyruvatedioxygenases are enzymes that catalyse the reaction in which para-hydroxyphenylpyruvate (HPP) is transformed into homogentisate. Plants tolerant to HPPD-inhibitors can be transformed with a gene encoding a naturally occurring resistant HPPD enzyme, or a gene encoding a mutated HPPD enzyme according to WO 1996/038567, WO 1999/024585 and WO 1999/024586. Tolerance to HPPD inhibitors can also be obtained by transforming plants with genes encoding certain enzymes enabling the formation of homogentisate despite the inhibition of the native HPPD enzyme by the HPPD inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Further herbicide-resistant plants are plants that have been made tolerant to acetolactate synthase (ALS) inhibitors. Known ALS-inhibitors include, for example, sulphonylurea, imidazolinone, triazolopyrimidines, pyrimidinyloxy(thio)benzoates, and/or sulphonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright, Weed Science (2002), 50, 700-712, but also in U.S. Pat. Nos. 5,605,011, 5,378,824, 5,141,870 and 5,013,659. The production of sulphonylurea-tolerant plants and imidazolinone-tolerant plants is described in U.S. Pat. Nos. 5,605,011; 5,013,659; 5,141,870; 5,767,361; 5,731,180; 5,304,732; 4,761,373; 5,331,107; 5,928,937; and 5,378,824; and international publication WO 1996/033270. Other imidazolinone-tolerant plants are also described in for example WO 2004/040012, WO 2004/106529, WO 2005/020673, WO 2005/093093, WO 2006/007373, WO 2006/015376, WO 2006/024351 and WO 2006/060634. Further sulphonylurea- and imidazolinone-tolerant plants are also described in for example WO 2007/024782.

Other plants tolerant to imidazolinone and/or sulphonylurea can be obtained by induced mutagenesis, selection in cell cultures in the presence of the herbicide or by mutation breeding as described for example for soya beans in U.S. Pat. No. 5,084,082, for rice in WO 1997/41218, for sugar beet in U.S. Pat. No. 5,773,702 and WO 1999/057965, for lettuce in U.S. Pat. No. 5,198,599 or for sunflower in WO 2001/065922.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

The term “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) in the Bacillus thuringiensis toxin nomenclature, online at: http://www.lifesci.sussex.ac.uk/Home/Neil_Crickmore/Bt/), or insecticidal portions thereof, e.g. proteins of the Cry protein classes Cry1Ab, Cry1Ac, Cry1F, Cry2Ab, Cry3Ae or Cry3Bb or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cy34 and Cy35 crystal proteins (Moellenbeck et al., Nat. Biotechnol. (2001), 19, 668-72; Schnepf et al., Applied Environm. Microb. (2006), 71, 1765-1774); or
3) a hybrid insecticidal protein comprising parts of two different insecticidal crystal proteins from Bacillus thuringiensis, such as a hybrid of the proteins of 1) above or a hybrid of the proteins of 2) above, e.g. the Cry1A.105 protein produced by maize event MON98034 (WO 2007/027777); or
4) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation, such as the Cry3Bb1 protein in maize events MON863 or MON88017, or the Cry3A protein in maize event MIR604; or
5) an insecticidal secreted protein from Bacillus thuringiensis or Bacillus cereus, or an insecticidal portion thereof, such as the vegetative insecticidal proteins (VIP) listed at: http://www.lifesci.sussex.ac.uk/home/Neil_Crickmore/Bt/vip.html, e.g. proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 1994/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation (while still encoding an insecticidal protein), such as the VIP3Aa protein in cotton event COT102.

Of course, insect-resistant transgenic plants, as used herein, also include any plant comprising a combination of genes encoding the proteins of any one of the abovementioned classes 1 to 8. In one embodiment, an insect-resistant plant contains more than one transgene encoding a protein of any one of the abovementioned classes 1 to 8, to expand the range of target insect species affected or to delay insect resistance development to the plants, by using different proteins insecticidal to the same target insect species but having a different mode of action, such as binding to different receptor binding sites in the insect.

Plants or plant cultivars (obtained by plant biotechnology methods such as genetic engineering) which may also be treated according to the invention are tolerant to abiotic stress factors. Such plants can be obtained by genetic transformation, or by selection of plants containing a mutation imparting such stress resistance. Particularly useful stress-tolerant plants include:
a. plants which contain a transgene capable of reducing the expression and/or the activity of the poly(ADP-ribose)polymerase (PARP) gene in the plant cells or plants as described in WO 2000/004173 or EP 04077984.5 or EP 06009836.5;
b. plants which contain a stress tolerance-enhancing transgene capable of reducing the expression and/or the activity of the PARG encoding genes of the plants or plant cells as described, for example, in WO 2004/090140;
c. plants which contain a stress tolerance-enhancing transgene coding for a plant-functional enzyme of the nicotinamide adenine dinucleotide salvage biosynthesis pathway, including nicotinamidase, nicotinate phosphoribosyltransferase, nicotinic acid mononucleotide adenyltransferase, nicotinamide adenine dinucleotide synthetase or nicotinamide phosphoribosyltransferase as described, for example, in EP 04077624.7 or WO 2006/133827 or PCT/EP07/002433.

Plants or plant cultivars (obtained by plant biotechnology methods such as genetic engineering) which may also be treated according to the invention show altered quantity, quality and/or storage stability of the harvested product and/or altered properties of specific ingredients of the harvested product such as:
1) transgenic plants which synthesize a modified starch, which in its physicochemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesized starch in wild type plant cells or plants, so that this modified starch is better suited for special applications. Said transgenic plants synthesizing a modified starch are described, for example, in EP 0571427, WO 1995/004826, EP 0719338, WO 1996/15248, WO 1996/19581, WO 1996/27674, WO 1997/11188, WO 1997/26362, WO 1997/32985, WO 1997/42328, WO 1997/44472, WO 1997/45545, WO 1998/27212, WO 1998/40503, WO 99/58688, WO 1999/58690, WO 1999/58654, WO 2000/008184, WO 2000/008185, WO 2000/28052, WO 2000/77229, WO 2001/12782, WO 2001/12826, WO 2002/101059, WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862, WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 1995/26407, WO 1996/34968, WO 1998/20145, WO 1999/12950, WO 1999/66050, WO 1999/53072, US 6,734,341, WO 2000/11192, WO 1998/22604, WO 1998/32326, WO 2001/98509, WO 2001/98509, WO 2005/002359, U.S. Pat. Nos. 5,824,790, 6,013,861, WO 1994/004693, WO 1994/009144, WO 1994/11520, WO 1995/35026 and WO 1997/20936.
2) transgenic plants which synthesize non-starch carbohydrate polymers or which synthesize non-starch carbohydrate polymers with altered properties in comparison to wild type plants without genetic modification. Examples are plants producing polyfructose, especially of the inulin and levan type, as described in EP 0663956, WO 1996/001904, WO 1996/021023, WO 1998/039460 and WO 1999/024593, plants producing alpha-1,4-glucans, as described in WO 1995/031553, US 2002/031826, U.S. Pat. Nos. 6,284,479, 5,712,107, WO 1997/047806, WO 1997/047807, WO 1997/047808 and WO 2000/14249, plants producing alpha-1,6-branched alpha-1,4-glucans, as described in WO 2000/73422, and plants producing alternan, as described in WO 2000/047727, EP 06077301.7, U.S. Pat. No. 5,908,975 and EP 0728213.
3) transgenic plants which produce hyaluronan, as for example described in WO 2006/032538, WO 2007/039314, WO 2007/039315, WO 2007/039316, JP 2006/304779 and WO 2005/012529.
   Plants or plant cultivars (obtained by plant biotechnology methods such as genetic engineering) which may also be treated according to the invention are plants, such as cotton plants, with altered fibre characteristics. Such plants can be obtained by genetic transformation, or by selection of plants containing a mutation imparting such altered fibre characteristics and include:
      a) plants, such as cotton plants, containing an altered form of cellulose synthase genes as described in WO 1998/000549,
      b) plants, such as cotton plants, containing an altered form of rsw2 or rsw3 homologous nucleic acids as described in WO 2004/053219;
      c) plants, such as cotton plants, with increased expression of sucrose phosphate synthase as described in WO 2001/017333;
      d) plants, such as cotton plants, with increased expression of sucrose synthase as described in WO 02/45485;
      e) plants, such as cotton plants, wherein the timing of the plasmodesmatal gating at the basis of the fibre cell is altered, for example through downregulation of fibre-selective β-1,3-glucanase as described in WO 2005/017157;
      f) plants, such as cotton plants, having fibres with altered reactivity, e.g. through the expression of the N-acetylglucosaminetransferase gene including nodC and chitin synthase genes as described in WO 2006/136351.

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation or by selection of plants containing a mutation imparting such altered oil characteristics and include:
a) plants, such as oilseed rape plants, producing oil having a high oleic acid content, as described, for example, in U.S. Pat. Nos. 5,969,169, 5,840,946 or 6,323,392 or 6,063,947;
b) plants, such as oilseed rape plants, producing oil having a low linolenic acid content, as described in U.S. Pat. Nos. 6,270828, 6,169,190 or 5,965,755.
c) plants, such as oilseed rape plants, producing oil having a low level of saturated fatty acids, as described, for example, in U.S. Pat. No. 5,434,283.

Particularly useful transgenic plants which may be treated according to the invention are plants which comprise one or more genes which encode one or more toxins are the transgenic plants which are sold under the following trade names: YIELD GARD® (for example maize, cotton, soya beans), KnockOut® (for example maize), BiteGard® (for example maize), BT-Xtra® (for example maize), StarLink® (for example maize), Bollgard® (cotton), Nucotn® (cotton), Nucotn 33B® (cotton), NatureGard® (for example maize), Protecta® and NewLeaf® (potato). Examples of herbicide-tolerant plants which may be mentioned are maize varieties, cotton varieties and soya bean varieties which are sold under the following trade names: Roundup Ready® (tolerance to glyphosate, for example maize, cotton, soya bean), Liberty Link® (tolerance to phosphinotricin, for example oilseed rape), IMI® (tolerance to imidazolinones) and SCS® (tolerance to sulphonylureas), for example maize. Herbicide-resistant plants (plants bred in a conventional manner for herbicide tolerance) which may be mentioned include the varieties sold under the Clearfield® name (for example maize).

Particularly useful transgenic plants which may be treated according to the invention are plants containing transformation events, or a combination of transformation events, that are listed for example in the databases from various national or regional regulatory agencies (see for example http://gmoinfo.jrc.it/gmp_browse.aspx and http://www.agbios.com/dbase.php).

The examples which follow serve to illustrate the invention, but without restricting it.

### EXAMPLE A

Control Efficacy against Wireworm in Wheat by Seed Treatment

Wheat seeds of the spring wheat variety Harvest were treated with Raxil Pro at the standard seed treatment rate of 325 ml per 100 kg of seed. In addition different rates of Tetraniliprole were treated in addition to the Raxil Pro or Raxil Pro Shield treatment. As commercial standards Nipsit Suite (Valent) and Cruiser Vibrance Quattro (Syngenta) were used at commercially recommended rates. Treated seeds were planted in spring in different locations in Alberta and Sasketchewan (Canada) between 29 Apr. 2016 and 17 May 2016 resulting in a fivefold (5 trials) replicated trial. Emergence of plants was observed between seven to fourteen days after seeding. Harvest of the crop was performed at five of the six sites between 7^{th} Sep. and 21 Oct. 2016.

Plant counts were performed 5 to 8 days after emergence.

TABLE 1

| | | Plant counts |
|---|---|---|
| | Rate | [% of Raxil |
| Treatment | [g/100 kg seeds) | Pro Treatment] |
| Raxil Pro | 1 (Tebuconazole) | 100 |
| | 5 (Prothioconazole) | |
| | 2 (Metalaxyl) | |
| Raxil Pro Shield | 1 (Tebuconazole) | 247.6 |
| | 5 (Prothioconazole) | |
| | 2 (Metalaxyl) | |
| | 30 (Imidacloprid) | |
| Cruiser V. Quattro | 20 (Thiamethoxam) | 161.4 |
| | 12 (Difenoconazole) | |
| | 5 (Sedaxane) | |
| | 3 (Metalaxyl-M | |
| | (and S-isomer)) | |
| | 2.5 (Fludioxonil) | |
| Nipsit Suite ( | 1.5 (Metconazole) | 180.6 |
| | 3 (Metalaxyl) | |
| | 10 (Clothianidin) | |
| Raxil Pro + | 1 (Tebuconazole) | 343.0 |
| Tetraniliprole | 5 (Prothioconazole) | |
| | 2 (Metalaxyl) | |
| | 25 (Tetraniliprole) | |
| Raxil Pro + | 1 (Tebuconazole) | 325.8 |
| Tetraniliprole | 5 (Prothioconazole) | |
| | 2 (Metalaxyl) | |
| | 50 (Tetraniliprole) | |
| Raxil Pro + | 1 (Tebuconazole) | 360.2 |
| Tetraniliprole | 5 (Prothioconazole) | |
| | 2 (Metalaxyl) | |
| | 75 (Tetraniliprole) | |
| Raxil Pro Shield + | 1 (Tebuconazole) | 428.0 |
| Tetraniliprole | 5 (Prothioconazole) | |
| | 2 (Metalaxyl) | |
| | 30 (Imidacloprid) | |
| | 10 (Tetraniliprole) | |

Plant counts were performed for one of the trials showing a very high wireworm pressure at 19 days after emergence.

TABLE 2

| | | Plant counts |
|---|---|---|
| | Rate | [% of Raxil |
| Treatment | [g/100 kg seeds) | Pro Treatment] |
| Raxil Pro | 1 (Tebuconazole) | 100 |
| | 5 (Prothioconazole) | |
| | 2 (Metalaxyl) | |
| Raxil Pro Shield | 1 (Tebuconazole) | 254.9 |
| (30 g) | 5 (Prothioconazole) | |
| | 2 (Metalaxyl) | |
| | 30 (Imidacloprid) | |
| Cruiser V. Quattro | 20 (Thiamethoxam) | 328.8 |
| | 12 (Difenoconazole) | |
| | 5 (Sedaxane) | |
| | 3 (Metalaxyl-M | |
| | (and S-isomer)) | |
| | 2.5 (Fludioxonil) | |
| Nipsit Suite ( | 1.5 (Metconazole) | 257.1 |
| | 3 (Metalaxyl) | |
| | 10 (Clothianidin) | |
| Raxil Pro + | 1 (Tebuconazole) | 356.7 |
| Tetraniliprole | 5 (Prothioconazole) | |
| | 2 (Metalaxyl) | |
| | 25 (Tetraniliprole) | |
| Raxil Pro + | 1 (Tebuconazole) | 367 |
| Tetraniliprole | 5 (Prothioconazole) | |
| | 2 (Metalaxyl) | |
| | 50 (Tetraniliprole) | |
| Raxil Pro + | 1 (Tebuconazole) | 384.1 |
| Tetraniliprole | 5 (Prothioconazole) | |
| | 2 (Metalaxyl) | |
| | 75 (Tetraniliprole) | |
| Raxil Pro Shield + | 1 (Tebuconazole) | 323.6 |
| Tetraniliprole | 5 (Prothioconazole) | |
| | 2 (Metalaxyl) | |
| | 30 (Imidacloprid) | |
| | 10 (Tetraniliprole) | |

Counts for damaged plants were performed for one of the trials showing a very high wireworm pressure at 19 days after emergence.

TABLE 3

| | | Number of |
|---|---|---|
| | Rate | damaged plants |
| Treatment | [g/100 kg seeds) | per m² |
| Raxil Pro | 1 (Tebuconazole) | 18 |
| | 5 (Prothioconazole) | |
| | 2 (Metalaxyl) | |
| Raxil Pro Shield | 1 (Tebuconazole) | 6.6 |
| (30 g) | 5 (Prothioconazole) | |
| | 2 (Metalaxyl) | |
| | 30 (Imidacloprid) | |
| Cruiser V. Quattro | 20 (Thiamethoxam) | 5.1 |
| | 12 (Difenoconazole) | |
| | 5 (Sedaxane) | |
| | 3 (Metalaxyl-M | |
| | (and S-isomer)) | |
| | 2.5 (Fludioxonil) | |
| Nipsit Suite ( | 1.5 (Metconazole) | 5.4 |
| | 3 (Metalaxyl) | |
| | 10 (Clothianidin) | |
| Raxil Pro + | 1 (Tebuconazole) | 2 |
| Tetraniliprole | 5 (Prothioconazole) | |
| | 2 (Metalaxyl) | |
| | 25 (Tetraniliprole) | |
| Raxil Pro + | 1 (Tebuconazole) | 2.3 |
| Tetraniliprole | 5 (Prothioconazole) | |
| | 2 (Metalaxyl) | |
| | 50 (Tetraniliprole) | |
| Raxil Pro + | 1 (Tebuconazole) | 1.8 |
| Tetraniliprole | 5 (Prothioconazole) | |
| | 2 (Metalaxyl) | |
| | 75 (Tetraniliprole) | |
| Raxil Pro Shield + | 1 (Tebuconazole) | 4.3 |
| Tetraniliprole | 5 (Prothioconazole) | |
| | 2 (Metalaxyl) | |
| | 30 (Imidacloprid) | |
| | 10 (Tetraniliprole) | |

NDVI measurements were performed for one of the trials showing a very high wireworm pressure at 19 days after emergence.

TABLE 4

| | Rate | Relative |
|---|---|---|
| Treatment | [g/100 kg seeds) | NDVI [%] |
| Raxil Pro | 1 (Tebuconazole) | 100 |
| | 5 (Prothioconazole) | |
| | 2 (Metalaxyl) | |
| Raxil Pro Shield | 1 (Tebuconazole) | 135.5 |
| (30 g) | 5 (Prothioconazole) | |
| | 2 (Metalaxyl) | |
| | 30 (Imidacloprid) | |
| Cruiser V. Quattro | 20 (Thiamethoxam) | 135.8 |
| | 12 (Difenoconazole) | |
| | 5 (Sedaxane) | |
| | 3 (Metalaxyl-M | |
| | (and S-isomer)) | |
| | 2.5 (Fludioxonil) | |
| Nipsit Suite ( | 1.5 (Metconazole) | 140.9 |
| | 3 (Metalaxyl) | |
| | 10 (Clothianidin) | |
| Raxil Pro + | 1 (Tebuconazole) | 157.2 |
| Tetraniliprole | 5 (Prothioconazole) | |
| | 2 (Metalaxyl) | |
| | 25 (Tetraniliprole) | |
| Raxil Pro + | 1 (Tebuconazole) | 159.2 |
| Tetraniliprole | 5 (Prothioconazole) | |
| | 2 (Metalaxyl) | |
| | 50 (Tetraniliprole) | |
| Raxil Pro + | 1 (Tebuconazole) | 166.3 |
| Tetraniliprole | 5 (Prothioconazole) | |
| | 2 (Metalaxyl) | |
| | 75 (Tetraniliprole) | |
| Raxil Pro Shield + | 1 (Tebuconazole) | 153.5 |
| Tetraniliprole | 5 (Prothioconazole) | |
| | 2 (Metalaxyl) | |
| | 30 (Imidacloprid) | |
| | 10 (Tetraniliprole) | |

Relative yield of grain was determined based on the control treated with fungicide only (Raxil Pro treatment) for five of the six sites

TABLE 5

| | Rate | Relative Yield |
|---|---|---|
| Treatment | [g/100 kg seeds) | [%] |
| Raxil Pro | 1 (Tebuconazole) | 100 |
| | 5 (Prothioconazole) | |
| | 2 (Metalaxyl) | |
| Raxil Pro Shield | 1 (Tebuconazole) | 127.96 |
| (30 g) | 5 (Prothioconazole) | |
| | 2 (Metalaxyl) | |
| | 30 (Imidacloprid) | |
| Cruiser V. Quattro | 20 (Thiamethoxam) | 125.9 |
| | 12 (Difenoconazole) | |
| | 5 (Sedaxane) | |
| | 3 (Metalaxyl-M | |
| | (and S-isomer)) | |
| | 2.5 (Fludioxonil) | |
| Nipsit Suite ( | 1.5 (Metconazole) | 125.25 |
| | 3 (Metalaxyl) | |
| | 10 (Clothianidin) | |
| Raxil Pro + | 1 (Tebuconazole) | 131.49 |
| Tetraniliprole | 5 (Prothioconazole) | |
| | 2 (Metalaxyl) | |
| | 25 (Tetraniliprole) | |
| Raxil Pro + | 1 (Tebuconazole) | 136.85 |
| Tetraniliprole | 5 (Prothioconazole) | |
| | 2 (Metalaxyl) | |
| | 50 (Tetraniliprole) | |
| Raxil Pro + | 1 (Tebuconazole) | 136.33 |
| Tetraniliprole | 5 (Prothioconazole) | |
| | 2 (Metalaxyl) | |
| | 75 (Tetraniliprole) | |
| Raxil Pro Shield + | 1 (Tebuconazole) | 130.86 |
| Tetraniliprole | 5 (Prothioconazole) | |
| | 2 (Metalaxyl) | |
| | 30 (Imidacloprid) | |
| | 10 (Tetraniliprole) | |

### EXAMPLE B

Control Efficacy against Wireworm in Wheat by Seed Treatment

Wheat seeds of the spring wheat variety Harvest were treated with Raxil Pro at the standard seed treatment rate of 325 ml per 100 kg of seed. In addition different rates of Tetraniliprole were treated in addition to the Raxil Pro or Raxil Pro Shield treatment. Treated seeds were planted in spring in different locations in Alberta and Sasketchewan (Canada) in spring 2017 resulting in a sixfold (6 trials) replicated trial. Emergence of plants was observed between seven to fourteen days after seeding. Harvest of the crop was performed in September/October 2017.

Plant counts were performed 4 to 8 days after emergence.

TABLE 6

| | Rate | Plant count [No |
|---|---|---|
| Treatment | [g/100 kg seeds) | plants/m²] |
| Raxil Pro | 1 (Tebuconazole) | 75.62 |
| | 5 (Prothioconazole) | |
| | 2 (Metalaxyl) | |
| Raxil Pro Shield (30 g) | 1 (Tebuconazole) | 95.2 |
| | 5 (Prothioconazole) | |
| | 2 (Metalaxyl) | |
| | 30 (Imidacloprid) | |
| Raxil Pro + | 1 (Tebuconazole) | 87.25 |
| Tetraniliprole | 5 (Prothioconazole) | |
| | 2 (Metalaxyl) | |
| | 20 (Tetraniliprole) | |
| Raxil Pro + | 1 (Tebuconazole) | 90.29 |
| Tetraniliprole | 5 (Prothioconazole) | |
| | 2 (Metalaxyl) | |
| | 25 (Tetraniliprole) | |
| Raxil Pro Shield + | 1 (Tebuconazole) | 104.39 |
| Tetraniliprole | 5 (Prothioconazole) | |
| | 2 (Metalaxyl) | |
| | 30 (Imidacloprid) | |
| | 10 (Tetraniliprole) | |

Counts for damaged plants were performed for four of the trials at 4 to 8 days after emergence.

TABLE 7

| | Rate | Damaged plants |
|---|---|---|
| Treatment | [g/100 kg seeds) | [% plants] |
| Raxil Pro | 1 (Tebuconazole) | 5.09 |
| | 5 (Prothioconazole) | |
| | 2 (Metalaxyl) | |
| Raxil Pro Shield (30 g) | 1 (Tebuconazole) | 3.21 |
| | 5 (Prothioconazole) | |
| | 2 (Metalaxyl) | |
| | 30 (Imidacloprid) | |
| Raxil Pro + | 1 (Tebuconazole) | 3.42 |
| Tetraniliprole | 5 (Prothioconazole) | |
| | 2 (Metalaxyl) | |
| | 20 (Tetraniliprole) | |
| Raxil Pro + | 1 (Tebuconazole) | 2.56 |
| Tetraniliprole | 5 (Prothioconazole) | |
| | 2 (Metalaxyl) | |
| | 25 (Tetraniliprole) | |
| Raxil Pro Shield + | 1 (Tebuconazole) | 1.77 |
| Tetraniliprole | 5 (Prothioconazole) | |
| | 2 (Metalaxyl) | |
| | 30 (Imidacloprid) | |
| | 10 (Tetraniliprole) | |

Vigour rating for plants were performed for four of the trials at 36 to 58 days after emergence.

Vigour rating is done by visual assessment of the plants on a scale from 1 to 9. 4 is the rating for a plant of standard vigour, a value of 1 represents the highest vigour.

TABLE 8

| | Rate | |
|---|---|---|
| Treatment | [g/100 kg seeds) | Vigou rating |
| Raxil Pro | 1 (Tebuconazole) | 4.69 |
| | 5 (Prothioconazole) | |
| | 2 (Metalaxyl) | |
| Raxil Pro Shield (30 g) | 1 (Tebuconazole) | 3.81 |
| | 5 (Prothioconazole) | |
| | 2 (Metalaxyl) | |
| | 30 (Imidacloprid) | |
| Raxil Pro + | 1 (Tebuconazole) | 3.56 |
| Tetraniliprole | 5 (Prothioconazole) | |
| | 2 (Metalaxyl) | |
| | 20 (Tetraniliprole) | |
| Raxil Pro + | 1 (Tebuconazole) | 3.19 |
| Tetraniliprole | 5 (Prothioconazole) | |
| | 2 (Metalaxyl) | |
| | 25 (Tetraniliprole) | |
| Raxil Pro Shield + | 1 (Tebuconazole) | 3.13 |
| Tetraniliprole | 5 (Prothioconazole) | |
| | 2 (Metalaxyl) | |
| | 30 (Imidacloprid) | |
| | 10 (Tetraniliprole) | |

Relative yield of grain was determined based on the control treated with fungicide only (Raxil Pro treatment) for six of the six sites.

TABLE 9

| | Rate | Relative Yield |
|---|---|---|
| Treatment | [g/100 kg seeds) | [%] |
| Raxil Pro | 1 (Tebuconazole) | 100 |
| | 5 (Prothioconazole) | |
| | 2 (Metalaxyl) | |
| Raxil Pro Shield (30 g) | 1 (Tebuconazole) | 138.27 |
| | 5 (Prothioconazole) | |
| | 2 (Metalaxyl) | |
| | 30 (Imidacloprid) | |
| Raxil Pro + | 1 (Tebuconazole) | 136.47 |
| Tetraniliprole | 5 (Prothioconazole) | |
| | 2 (Metalaxyl) | |
| | 10 (Tetraniliprole) | |
| Raxil Pro + | 1 (Tebuconazole) | 134.23 |
| Tetraniliprole | 5 (Prothioconazole) | |
| | 2 (Metalaxyl) | |
| | 15 (Tetraniliprole) | |
| Raxil Pro + | 1 (Tebuconazole) | 142.01 |
| Tetraniliprole | 5 (Prothioconazole) | |
| | 2 (Metalaxyl) | |
| | 20 (Tetraniliprole) | |
| Raxil Pro + | 1 (Tebuconazole) | 136.76 |
| Tetraniliprole | 5 (Prothioconazole) | |
| | 2 (Metalaxyl) | |
| | 25 (Tetraniliprole) | |
| Raxil Pro + | 1 (Tebuconazole) | 141.57 |
| Tetraniliprole | 5 (Prothioconazole) | |
| | 2 (Metalaxyl) | |
| | 30 (Tetraniliprole) | |

1. A product comprising at least one insecticide selected from the group of consisting of Tetraniliprole, Cyclaniliprole, and Flubendiamide, for control of wireworms.

2. The method according to claim 11, wherein the insecticide is Tetraniliprole.

3. The method according to claim 11, wherein the insecticide is Flubendiamide.

4. The method according to claim 11, wherein the wireworms are controlled in crops.

5. The method according to claim 11, wherein the crops are selected from the group consisting of wheat, barley, rye, oats, triticale, corn, beans, lentils, peas, sunflower.

6. The method according to claim 11, wherein the crop is wheat.

7. Method according to claim 11, wherein wireworms are larvae of the species selected from the group comprising Agriotes mancus, Hypnoidus bicolor, Limonius californicus, Selatosomus destructor, Limonius ectypus.

8. Method according to claim 11, wherein at least one insecticide selected from the group of consisting of Tetraniliprole, Cyclaniliprole, and Flubendiamide is employed in combination with a further active ingredient.

9. A method for controlling wireworms in one or more plants or plant parts, comprising treating the plants and/or plant parts with at least one insecticide selected from the group of consisting of Tetraniliprole, Cyclaniliprole, and Flubendiamide.

10. Method according to claim 8, wherein the seeds of plants are treated with at least one insecticide.

11. A method for controlling wireworms in seed and/or in one or more plants which grow from the seed, comprising treating soil around the seed and/or the plants with at least one insecticide selected from the group of consisting of Tetraniliprole, Cyclaniliprole, and Flubendiamide.

12. A method of claim 11, wherein the plants are young plants.
